(19) United States
(12) Patent Application Publication
(10) Pub. No.: US 2016/0048070 A1
(43) Pub. Date: Feb. 18, 2016

(54) IMAGE STABILIZER WITH EXTENDED POWER SOURCE

(71) Applicant: Jeffrey Overall, Fountain Valley, CA (US)

(72) Inventor: Jeffrey Overall, Fountain Valley, CA (US)

(21) Appl. No.: 14/461,170

(22) Filed: Aug. 15, 2014

(51) Int. Cl. G03B 17/56; H04N 5/225

(52) U.S. Cl. CPC G03B 17/561; H04N 5/225

(57) ABSTRACT

The present invention generally relates to devices for stabilizing and holding devices that record visual images (e.g., cameras, smartphones, etc.), where the devices have integrated power sources (e.g., batteries), and methods related to such devices. In one aspect, the present invention is directed to a device for stabilizing a camera, wherein the device comprises: a stabilizer body; a power source (e.g., battery) included within the stabilizer body; a camera mount connected to the stabilizer body; an internal power bridge connecting the battery pack to a power out supply; an exterior power bridge connected to the power out supply; a camera attached to the exterior power bridge, wherein the camera is attached to the camera mount.

### FIELD OF THE INVENTION

The present invention generally relates to devices for stabilizing and holding visual image recorders. (e.g., cameras, smartphones, etc.), where the devices have integrated power sources (e.g., batteries), and methods related to such devices.

### BACKGROUND OF THE INVENTION

There has been research and development directed to devices for stabilizing and holding cameras. For instance, U.S. Pat. No. 5,121,147 is allegedly directed to the following: “In order to provide a compact carrying handle arrangement for a video camera which is not provided with carrying handle connections per se, the lower horizontally extending portion of an essentially C-shaped handle extends along the lower edge of the camera and is secured thereto by a screw which is threaded into the threaded bore provided for connecting the tripod. The vertical portion of the handle has a connection site which can operatively engage with a first battery mounting site provided on the rear of the camera. A second battery site is provided on the handle and is arranged to receive the battery. The second mounting site is electrically connected with the connection site so that power from the battery can be supplied to the camera via the first battery mounting site. The grip portion of the handle extends forward in a space relationship over the top of the camera. Hot shoes are formed at the leading end of the grip portion and operatively connected with the second battery mounting site so as to enable power to be supplied thereto from the battery.” Abstract.

In addition, U.S. Pat. No. 6,056,450 is allegedly directed to the following: “A camera support device for elevating a camera above its operator. The device provides a stable support and allows the operator to manually control the camera's field of view. The device comprises a support base, a rotatable telescoping pole and a tiltable camera mount at the top of the pole that may be manually controlled. The tilt control of the camera mount is preferably provided by a spring lever which biases the camera platform to rotate forward. A cable is attached to the camera mount and is used to apply resistance to the spring lever and to rotate the camera backwards. The lower end of the cable is attached to a control arm connected to the pole at a location that is accessible by the operator. The camera's field of view may be manually raised or lowered by lowering or raising the control wire respectively. In addition, the camera may be manually panned left or right by rotating the pole accordingly. The use of manual control over the camera's field of view is often preferable to the use of motor controls, and particularly, where the camera and support device are to be used to film or record events over a large area, a significant distance from the camera.” Abstract.

Despite such research and development, there is still a need in the art for new devices, and related methods, for stabilizing and holding cameras.

### BRIEF DESCRIPTION OF THE DRAWINGS

FIG. 1 shows a general embodiment of a device (102) according to the present invention.

FIG. 2 shows three different types of visual image recorder (e.g., camera) mounts—2A, 2B and 2C.

FIG. 3 shows a device where there are two grips connected to a circular stabilizer body.

FIG. 4 shows a device including a grip connected to a curved stabilizer body.

FIG. 5 shows a different device including a grip connected to a curved stabilizer body.

FIG. 6 shows a device including a grip connected to a “U-shaped” stabilizer body.

FIG. 7A shows a device including a grip connected to a stabilizer body, where the grip includes a backup power source (e.g., battery), which is further connected to a visual image recorder (e.g., camera) mount, while FIG. 7B shows a cutaway image of the device of 7A.

FIG. 8A shows a device including a grip connected to a stabilizer body through a gimbal mount, while FIG. 8B shows a cutaway image of the power source case of the device of 8A.

FIG. 9A shows a device including a grip connected to a stabilizer body through a gimbal mount, where a power source (e.g., battery) is included in the grip, while FIG. 9B shows a cutaway image of the device shown in 9A.

FIG. 10A shows a device where the stabilizer body includes a tripod. FIG. 10B shows a cutaway image of the battery pack of the device of 10A, while FIG. 10C shows a side view of the battery pack and visual image recorder (e.g., camera) of the device of 10A.

FIG. 11A shows a device where the stabilizer body is a pole. FIG. 10B shows a cutaway image of the power source pack of the device of 11A, while FIG. 11C shows a side view of the battery pack and visual image recorder (e.g., camera) of the device of 11A.

FIG. 12A shows a device where there are two grips connected to a circular stabilizer body and where there is a power source (e.g., battery) included in a cross bar. FIG. 12B shows a cutaway image of the device of 12A.

FIG. 13A shows a device including a grip connected to a “U-shaped” stabilizer body, where a power source (e.g., battery) is included within the grip. FIG. 13B shows a cutaway image of the device of 13A.

FIG. 14A shows a device where the stabilizer body includes a tripod and where a power source (e.g., battery) is included in a leg of the tripod. FIG. 14B shows a cutaway image of the device of 14A.

FIG. 15A shows a device where the stabilizer body is a pole and where a power source (e.g., battery) is included within the pole. FIG. 15B shows a cutaway image of the device of 15A.

FIG. 16A shows a device shows a device where the stabilizer body includes a tripod and where a power source (e.g., battery) is included in a center tube used to raise or lower the visual image recorder on the tripod. FIG. 16B shows a cutaway image of the device of 16A.

### SUMMARY OF THE INVENTION

In one aspect, the present invention is directed to a device for stabilizing a visual image recorder (e.g., camera), wherein the device comprises: a stabilizer body; a power source (e.g., battery) included within the stabilizer body; a visual image recorder (e.g., camera) mount connected to the stabilizer body; an internal power bridge connecting the battery pack to a power out supply: an exterior power bridge connected to the power out supply; a visual image recorder (e.g., camera) attached to the exterior power bridge, wherein the visual image recorder (e.g., camera) is attached to the camera mount.

In another aspect, the present invention is directed to a device for stabilizing a visual image recorder (e.g., camera), wherein the device comprises: a stabilizer body; a power source connected to the stabilizer body; a visual image recorder (e.g., camera) mount connected to the stabilizer body; an internal power bridge connecting the battery pack to a power out supply; an exterior power bridge connected to the power out supply; a visual image recorder (e.g., camera) attached to the exterior power bridge, wherein the camera is attached to the visual image recorder (e.g., camera) mount.

### DETAILED DESCRIPTION OF THE INVENTION

The present invention generally relates to devices for stabilizing and holding visual image recorders (e.g., cameras), where the devices have integrated power sources (e.g., batteries), and methods related to such devices.

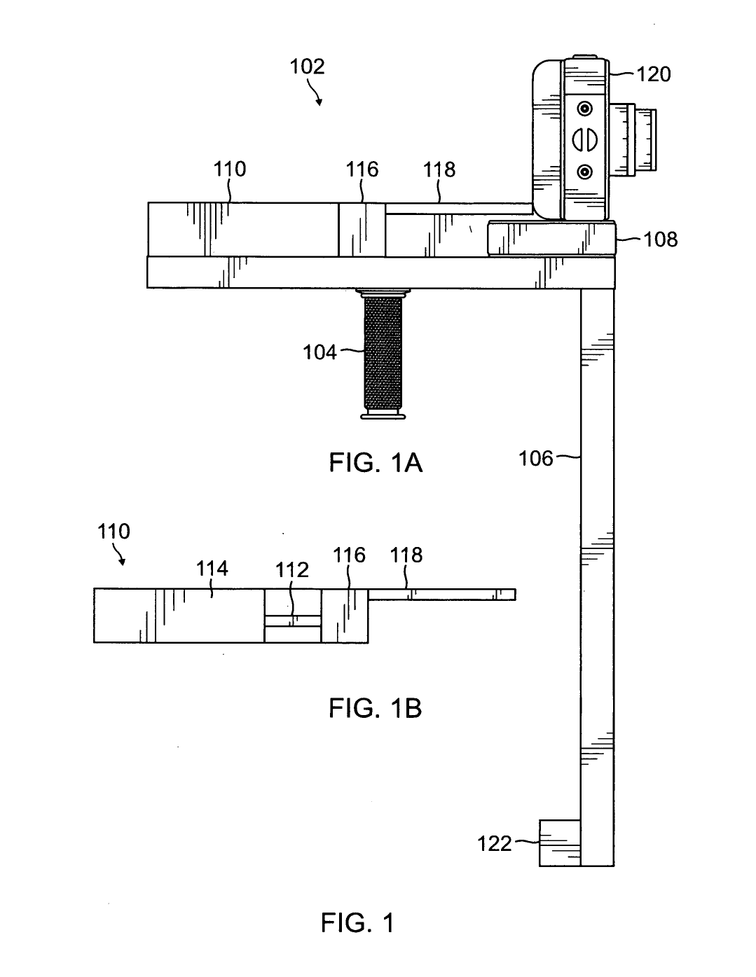

FIG. 1A shows a general embodiment of a device (102) according to the present invention. Grip 104 is connected to a stabilizer body (106), which is further connected to visual image recorder (e.g., camera) mount 108. Power source case 110 (e.g., battery pack case) is also connected to the stabilizer body 106. An internal power bridge (112, FIG. 1B) connects power pack 114 (FIG. 1B) (e.g., battery pack) to a power out supply (116), which is connected to an exterior power bridge (118). Exterior power bridge 118 is connected to visual image recorder (e.g., camera) 120. Visual image recorder (e.g., camera) 120 is attached to visual image recorder (e.g., camera) mount 108. Optional counterweight (122) is connected to stabilizer body 106.

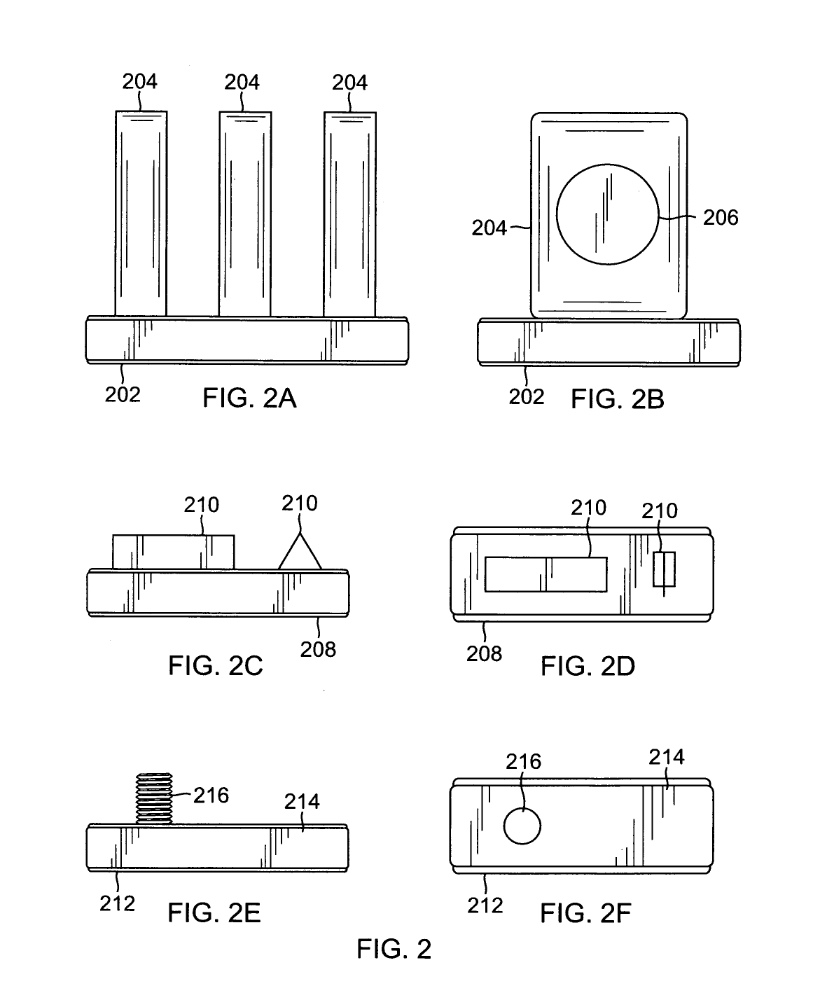

FIG. 2 shows three different types of visual image recorder (e.g., camera) mounts—2A (front view)/2B (side view). 2C (side view)/2D (top view) and 2E (side view)/2F (top view). The visual image recorder (e.g., camera) mount shown in 2A/2B (202) consists of three prongs (204) which connect to a visual image recorder (e.g., camera) through insertion of a pin-type structure into through-hole 206. The visual image recorder (e.g., camera) mount shown in 2C/2I) (208) consists of a snapping mechanism (210), which allows a visual image recorder (e.g., camera) to be snap-mounted onto a device. The visual image recorder (e.g., camera) mount shown in 2E/2F (212) consists of a landing (214), allowing a visual image recorder (e.g., camera) to be screw-mounted onto a device, and screw mount 216.

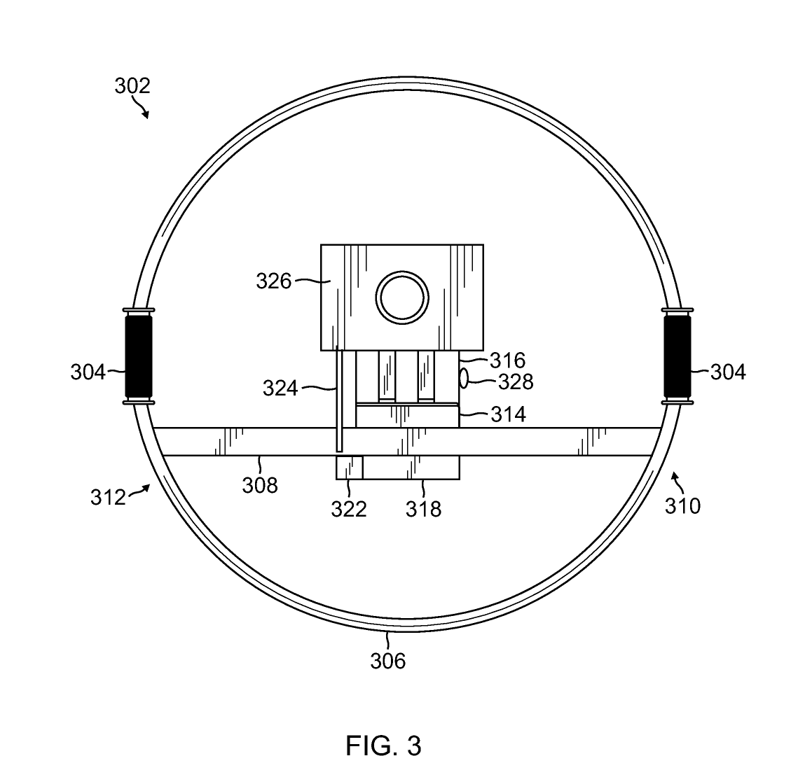

FIG. 3 shows a device (302) where there are two grips (304) connected to a circular stabilizer body (306), which also includes a cross bar (308) extending from proximal side (310) of circular stabilizer body 306 to distal side (312). Visual image recorder (e.g., camera) mount 314 is connected to cross bar 308, typically approximately mid-way between proximal side 310 and distal side 312. As shown, visual image recorder (e.g., camera) mount 314 includes three prongs (316) as shown in more detail in FIG. 2A, although any suitable mount will due—e.g., mounts shown in FIGS. 2C/D and 2E/F. Power pack 318 (e.g., battery pack) is connected to cross bar 308 beneath visual image recorder (e.g., camera) mount 314. An internal power bridge (320) connects power pack 318 to a power out supply (322), which is connected to an exterior power bridge (324). Exterior power bridge 324 is connected to visual image recorder (e.g., camera) 326. Visual image recorder (e.g., camera) 326 is attached to visual image recorder (e.g., camera) mount 314.

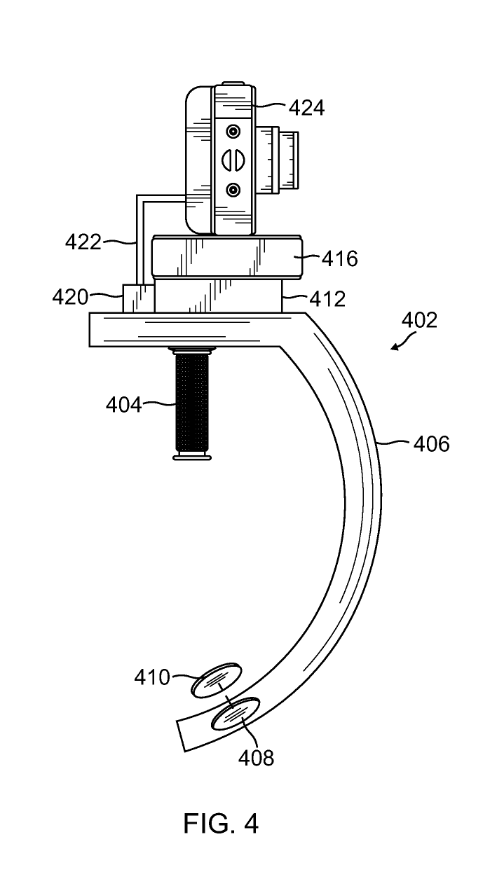

FIG. 4 shows a device (402) including a grip (404) connected to a curved stabilizer body (406). Curved stabilizer body 406 includes a slot (408) to which one or more counter weights (410) can be attached, and through which the position of the counter weight can be manipulated. Power pack case 412 (e.g., battery pack case), in which power pack 414 (e.g., battery pack) is included (not shown), is attached to the top portion of curved stabilizer body 406, approximately above where grip 404 connects to stabilizer body 406. Power pack case 412 is connected to visual image recorder (e.g., camera) mount 416. An internal power bridge (420, not shown) connects power pack 414 (through power pack case 412) to a power out supply (420), which is connected to an exterior power bridge (422). Exterior power bridge 422 is connected to visual image recorder (e.g., camera) 424. Visual image recorder (e.g., camera) 424 is attached to visual image recorder (e.g., camera) mount 416.

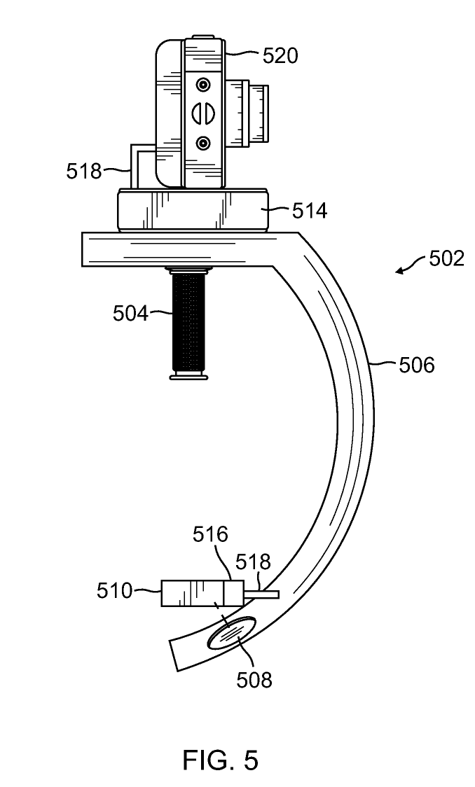

FIG. 5 shows a device (502) including a grip (504) connected to a curved stabilizer body (506). Curved stabilizer body 506 includes a slot (508) to which a power case (510) (e.g., battery case), including power pack 512 (e.g., battery pack, not shown), can be attached, and through which the position of power case 510 can be manipulated. Visual image recorder (e.g., camera) mount 514 is attached to the top of curved stabilizer body 506, approximately on top of where grip 504 attaches to stabilizer body 506. An internal power bridge (514, not shown) connects power pack 512 (through power case 510), to a power out supply (516), which is connected to an exterior power bridge (518). Exterior power bridge 518 passes up along or through the stabilizer body to connect to visual image recorder (e.g., camera) 520. Visual image recorder (e.g., camera) 520 is attached to visual image recorder (e.g., camera) mount 514.

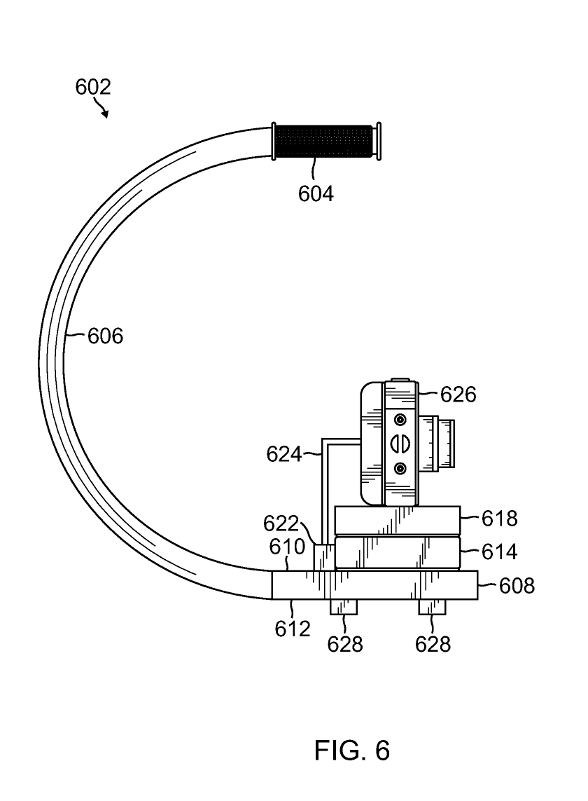

FIG. 6 shows a device (602) including a grip (604) connected to a “U-shaped” stabilizer body (606). At an end opposite to grip 604, a platform (608) is attached to stabilizer body 606. The platform has an internal side (610) and an external side (612). To internal side 610 is attached a power pack case (614) (e.g., battery pack case), including power pack 616 (e.g., battery pack, not shown). Power case 614 is connected to visual image recorder (e.g., camera) mount 618. An internal bridge (620) connects power pack 616 (through power pack case 614) to a power out supply (622), which is connected to an exterior power bridge (624). Exterior power bridge 624 is connected to visual image recorder (e.g., camera) 626. Visual image recorder (e.g., camera) 626 is attached to visual image recorder (e.g., camera) mount 618. Optional feet (628) may be attached to the external side 612 of platform 608.

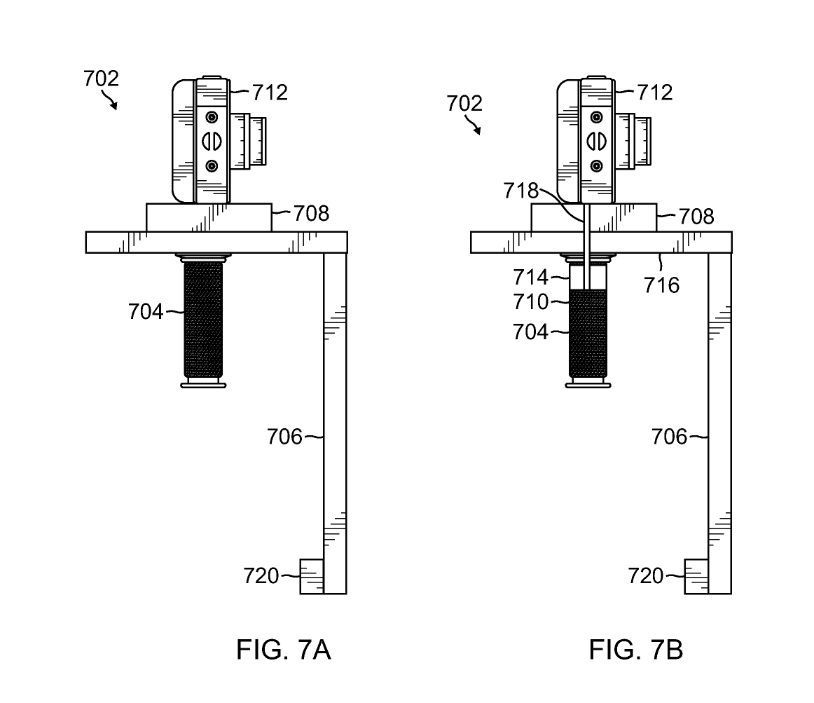

FIG. 7A shows a device (702) including a grip (704) connected to a stabilizer body (706), which is further connected to visual image recorder (e.g., camera) mount 708. Power pack 710 (e.g., battery pack, not shown) is included in grip 704. Camera 712 is attached to visual image recorder (e.g., camera) mount 708. Optional counterweight (720) is connected to stabilizer body 706.

FIG. 7B shows a cutaway image of device 702. Power source 710 (e.g., battery) is connected to an internal power bridge (714), which is connected to a power out supply (716). Power out supply 716 is connected to exterior power bridge (718). Exterior power bridge 718 is connected to visual image recorder (e.g., camera) 712, which is attached to visual image recorder (e.g., camera) mount 708.

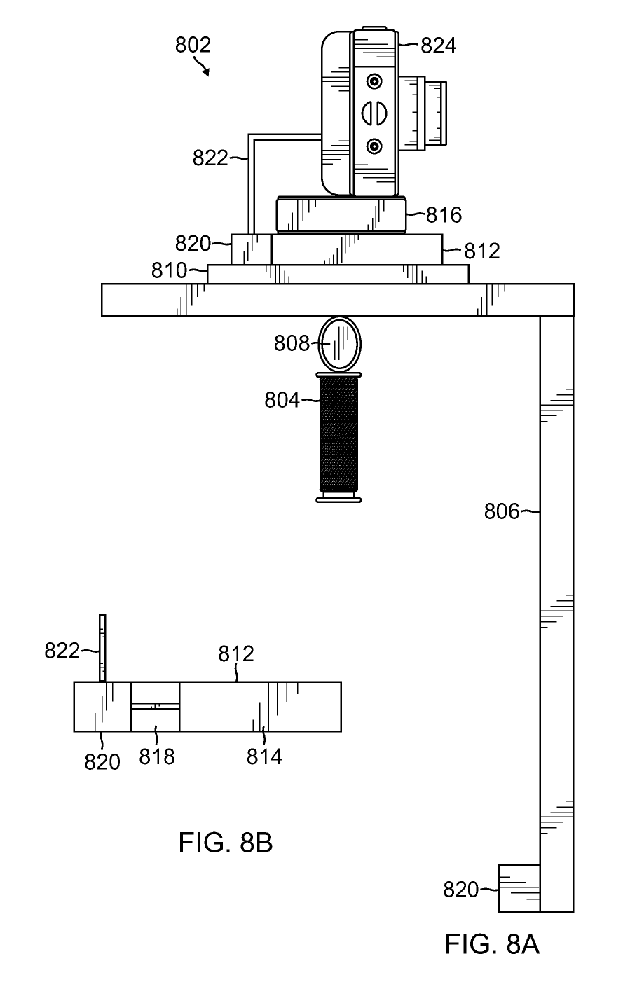

FIG. 8A shows a device (802) including a grip (804) connected to a stabilizer body (806) through a gimbal mount (808). A platform (810) is connected to stabilizer body 806, to which is connected power pack case 812 (e.g., battery pack case) in which power pack 814 (e.g., battery pack) is included (FIG. 8B). Visual image recorder (e.g., camera) mount 816 is connected to power pack case 812. An internal power bridge (818, FIG. 8B) connects power pack 814 (through power pack case 812, FIG. 8B) to a power out supply (820), which is connected to an exterior power bridge (822). Exterior power bridge 822 is connected to visual image recorder (e.g., camera) 824. Visual image recorder (e.g., camera) 824 is attached to visual image recorder (e.g., camera) mount 816.

FIG. 8B shows a cutaway image of power pack case 812 of device 802.

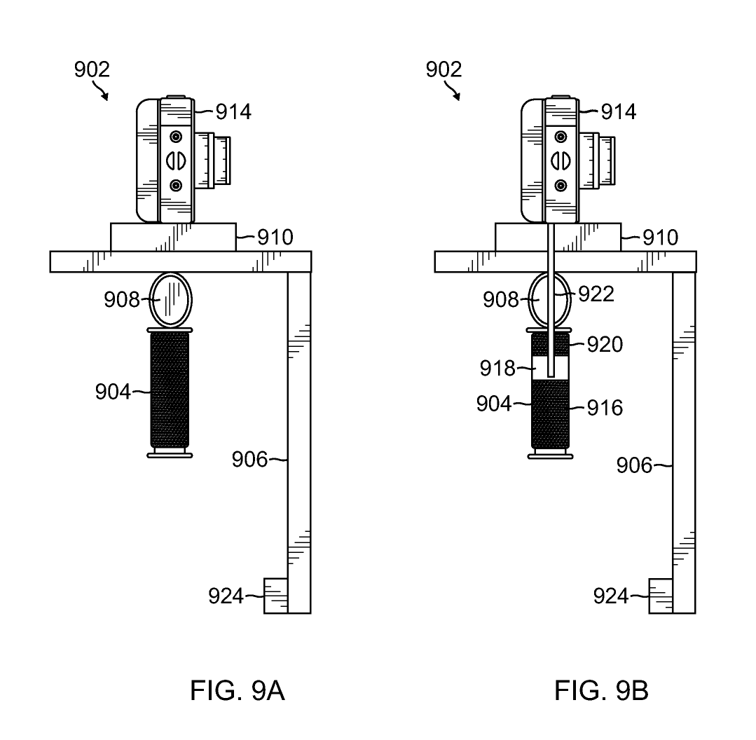

FIG. 9A shows a device (902) including a grip (904) connected to a stabilizer body (906) through a gimbal mount (908). Stabilizer body 906 is further connected to visual image recorder (e.g., camera) mount 910. Power pack 912 (e.g., battery pack, not shown) is included in grip 904. Visual image recorder (e.g., camera) 914 is attached to visual image recorder (e.g., camera) mount 910. Optional counterweight (924) is connected to stabilizer body 906.

FIG. 9B shows a cutaway image of device 902. Power pack 916 is connected to an internal power bridge (918), which is connected to a power out supply (920). Power out supply 920 is connected to exterior power bridge 922. Exterior power bridge 922 is connected to visual image recorder (e.g., camera) 914, which is attached to visual image recorder (e.g., camera) mount 910. Optional counterweight (924) is connected to stabilizer body 906.

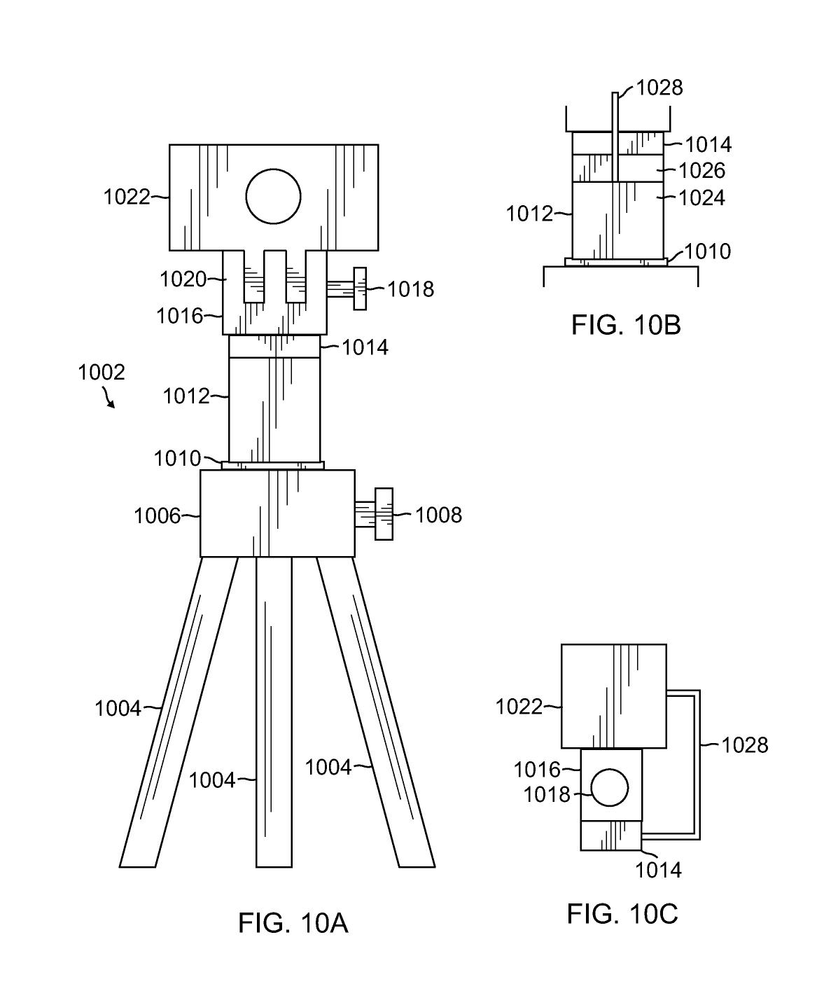

FIG. 10A shows a tripod device (1002) including three legs (1004), which may or may not be adjustable. Legs 1004 are attached to connecting piece (1006), which optionally includes controller 1008 for movement of platform 1010. Power case (1012) (e.g., battery case) sits on top of platform 1110 and is connected to power out supply 1014. Visual image recorder (e.g., camera) mount 1016—three pronged (1020) as shown, with a pin (1018) holding visual image recorder (e.g., camera) 1022 in place, although any suitable mount will work—is attached to power out supply 1014.

FIG. 10B shows a cut-away view of power case 1012 (e.g., battery case) and power out supply 1014. Case 1012 contains power pack 1024 (e.g., battery pack). Interior power supply 1026 connects power pack 1024 to power out supply 1014, and exterior power supply 1028 connects supply 1014 to visual image recorder (e.g., camera) 1022. This is shown from a side view in FIG. 10C.

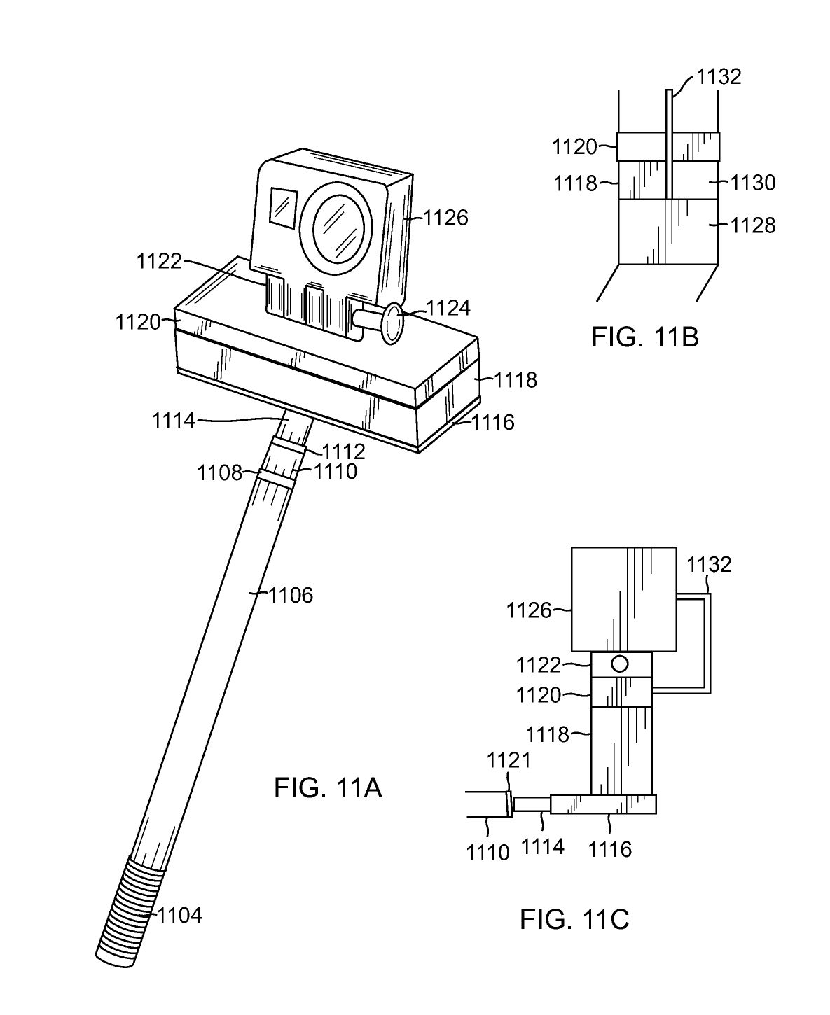

FIG. 11A shows a pole device (1102). Device 1102 includes a handle (1104) connected to a pole. As shown the pole consists of three extensible pieces (1106, 1110 and 1114) including twist locks 1108 and 1112 that permit extension of the pole. The pole, however, may also consist of a single non-extensible piece or multiple non-extensible pieces. Extensible piece 1014 is attached to platform 1116, on which sits power case 1118 (e.g., battery case). Case 1118 is connected to power out supply 1120, to which visual image recorder (e.g., camera) mount 1122 is attached (three-prong mount as shown, with pin 1124, although any suitable mount will work). Visual image recorder (e.g., camera) 1126 is connected to mount 1122.

FIG. 11B shows a cut-away view of power case 1118 and power supply 1120. Case 1118 contains power pack 1128 (e.g., battery pack). Interior power supply 1130 connects pack 1128 to power out supply 1120, and exterior power supply 1132 connects supply 1120 to visual image recorder (e.g., camera) 1126. This is shown from a side view in FIG. 11C.

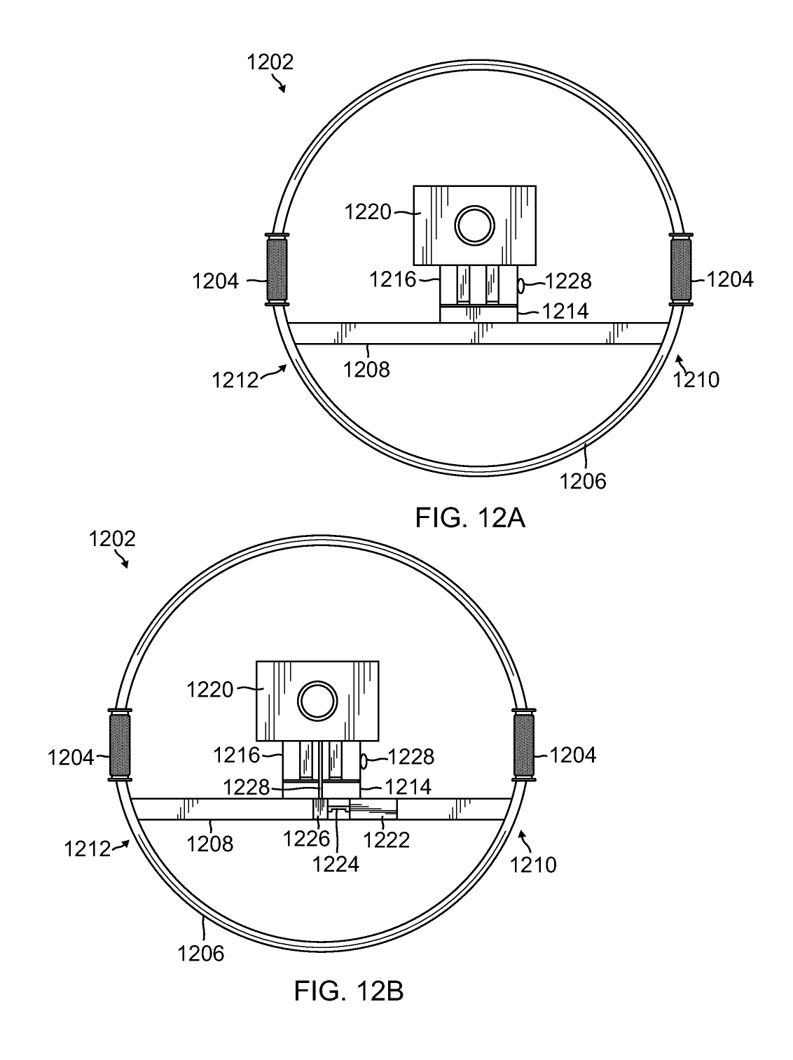

FIG. 12A shows a device (1202) where there are two grips (1204) connected to a circular stabilizer body (1206), which also includes a cross bar (1208) extending from proximal side (1210) of circular stabilizer body 1206 to distal side (1212). Visual image recorder (e.g., camera) mount 1214 is connected to cross bar 1208, typically approximately mid-way between proximal side 1210 and distal side 1212. As shown, visual image recorder (e.g., camera) mount 1214 includes three prongs (1216) as shown, although any suitable mount will due—e.g., mounts shown in FIGS. 2C/D and 2E/F. Visual image recorder (e.g., camera) 1220 is attached to visual image recorder (e.g., camera) mount 1214, using pin 1218.

FIG. 12B shows a cut-away view of FIG. 12A. The various elements shown in FIG. 12A are also shown in FIG. 12B. In addition, a cut-away of cross bar 1208 is shown. A power source (1222) (e.g., battery) is connected to an interior power bridge (1224). Interior power bridge 1224 is connected to a power out supply (1226). Power out supply 1226 is connected to exterior power supply 1228, which is connected to visual image recorder (e.g., camera) 1220.

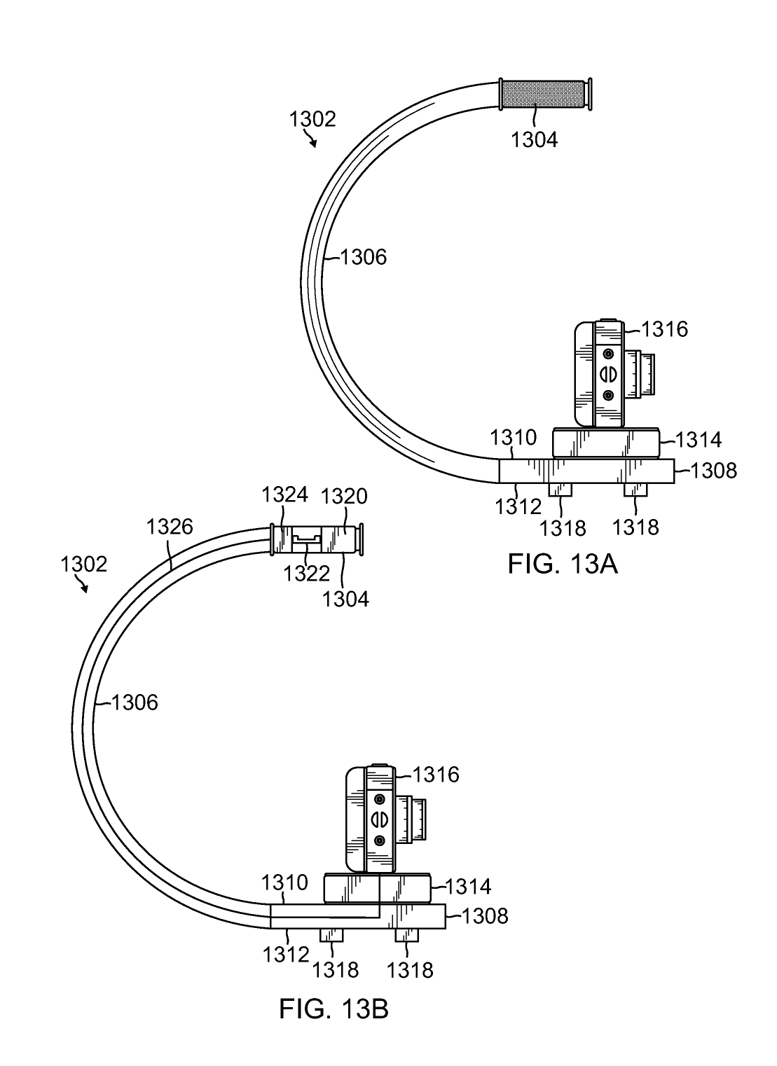

FIG. 13A shows a device (1302) including a grip (1304) connected to a “U-shaped” stabilizer body (1306). At an end opposite to grip 1304, a platform (1308) is attached to stabilizer body 1306. The platform has an internal side (1310) and an external side (1312). To internal side 1310 is attached visual image recorder (e.g., camera) mount 1314. Visual image recorder (e.g., camera) 1316 is attached to visual image recorder (e.g., camera) mount 1314.

FIG. 13B shows a cut-away view of FIG. 13A. The various elements shown in FIG. 13A are also shown in FIG. 13B. In addition, a cut-away of stabilizer body 1306 is shown. A power source (1320) (e.g., battery) is connected to an interior power bridge (1322). Interior power bridge 1322 is connected to a power out supply (1324). Power out supply 1324 is connected to exterior power supply 1326, which is connected to visual image recorder (e.g., camera) 1316.

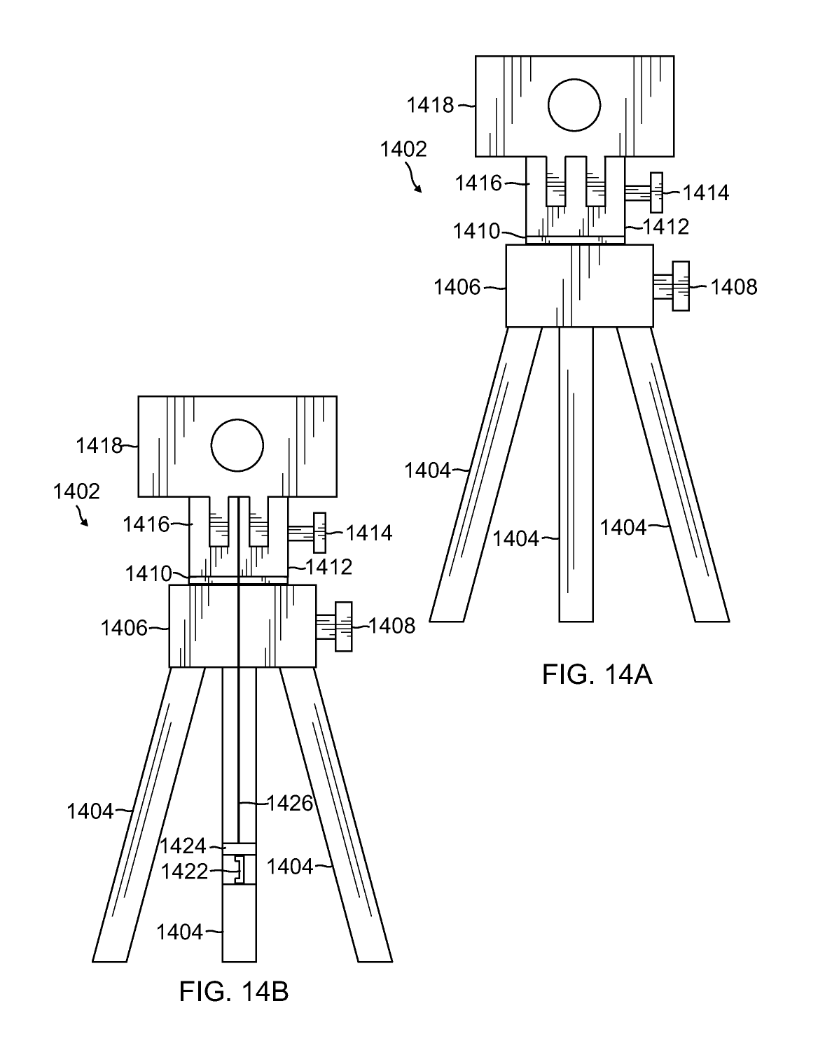

FIG. 14A shows a tripod device (1402) including three legs (1404), which may or may not be adjustable. Legs 1404 are attached to connecting piece (1406), which optionally includes controller 1408 for movement of platform 1410. Visual image recorder (e.g., camera) mount 1412—three pronged (1416) as shown, with a pin (1414)—holds visual image recorder (e.g., camera) 1418 in place, although any suitable mount will work.

FIG. 14B shows a cut-away view of FIG. 14A. The various elements shown in FIG. 14A are also shown in FIG. 14B. In addition, a cut-away of tripod leg 1404 is shown. A power source (1420) (e.g., battery) is connected to an interior power bridge (1422). Interior power bridge 1422 is connected to a power out supply (1424). Power out supply 1424 is connected to exterior power supply 1426, which is connected to visual image recorder (e.g., camera) 1418.

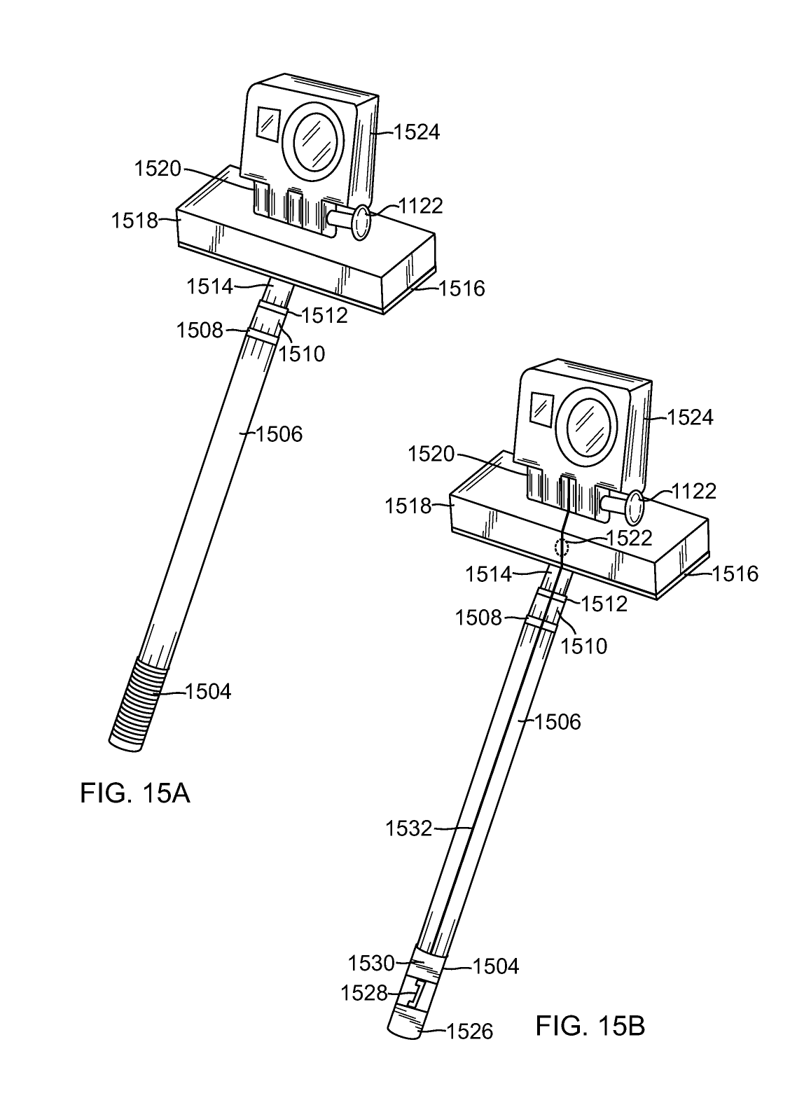

FIG. 15A shows a pole device (1502). Device 1502 includes a handle (1504) connected to a pole. As shown the pole consists of three extensible pieces (1506, 1510 and 1514) including twist locks 1508 and 1512 that permit extension of the pole. The pole, however, may also consist of a single non-extensible piece or multiple non-extensible pieces. Extensible piece 1514 is attached to platform 1516. Visual image recorder (e.g., camera) mount 1518 is attached (three-prong (1520) mount as shown, with pin 1522, although any suitable mount will work) platform 1516. Visual image recorder (e.g., camera) 1524 is connected to mount 1518.

FIG. 15B shows a cut-away view of FIG. 15A. The various elements shown in FIG. 15A are also shown in FIG. 15B. In addition, a cut-away of the pole is shown. A power source (1526) (e.g., battery) is connected to an interior power bridge (1528). Interior power bridge 1528 is connected to a power out supply (1530). Power out supply 1530 is connected to exterior power supply 1532, which is connected to visual image recorder (e.g., camera) 1524.

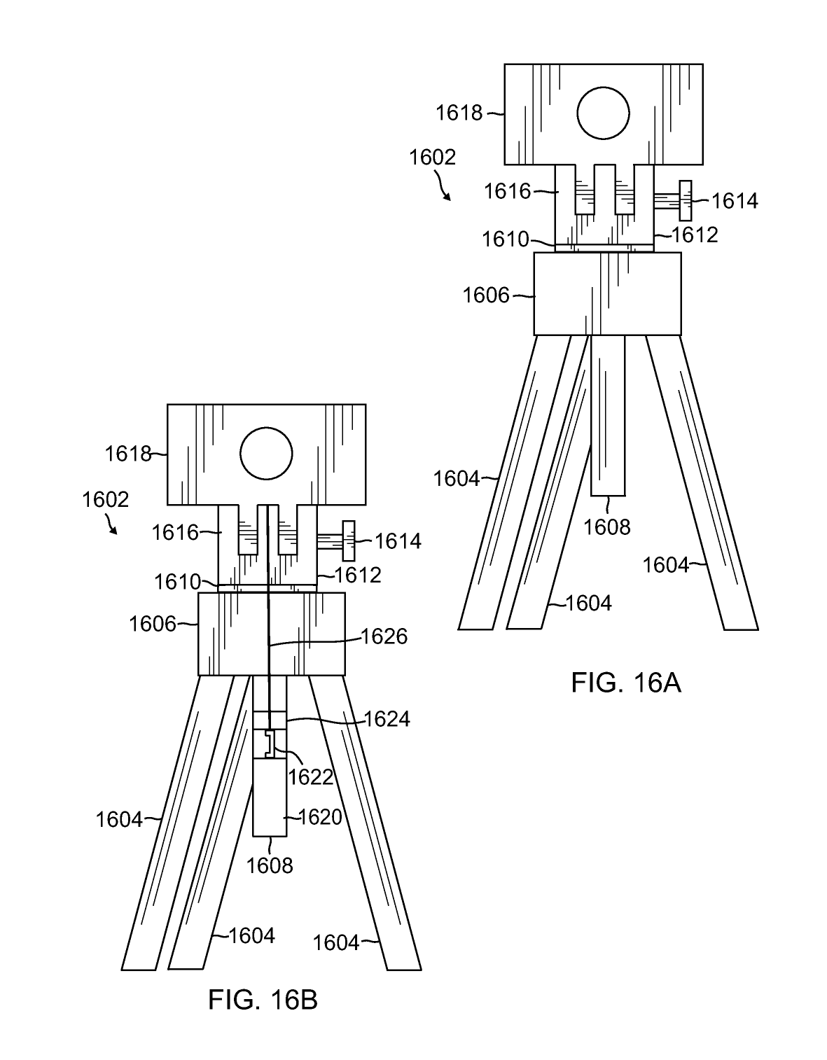

FIG. 16A shows a tripod device (1602) including three legs (1604), which may or may not be adjustable. Legs 1604 are attached to connecting piece (1606). A center tube (1608) used to raise or lower visual image recorder (e.g., camera) 1618 is also attached to connecting piece 1606. Visual image recorder (e.g., camera) mount 1612 is attached to platform (1610), which is connected to piece 1606. Visual image recorder (e.g., camera) mount 1612—three pronged (1616) as shown, with a pin (1614)—holds visual image recorder (e.g., camera) 1618 in place, although any suitable mount will work.

FIG. 16B shows a cut-away view of FIG. 16A. The various elements shown in FIG. 16A are also shown in FIG. 16B. In addition, a cut-away of center tube 1608 is shown. A power source (1620) (e.g., battery) is connected to an interior power bridge (1622). Interior power bridge 1622 is connected to a power out supply (1624). Power out supply 1624 is connected to exterior power supply 1626, which is connected to visual image recorder (e.g., camera) 1618.

Any suitable power source (e.g., battery or battery pack) can be used in a device of the present invention. In the case of a battery pack, one example is a 3.7V battery such as a rechargeable lithium ion battery from GOPRO®. In the case of a battery, one example is a cylindrical, 3.7V battery such as an 18650 rechargeable lithium ion battery.

1. (canceled)

2. A device for stabilizing a camera, wherein the device comprises:
a) a stabilizer body;
b) a battery pack included within the stabilizer body;
c) a camera mount connected to the stabilizer body;
d) an internal power bridge connecting the battery pack to a power out supply;
e) an exterior power bridge connected to the power out supply;
f) a camera attached to the exterior power bridge, wherein the camera is attached to the camera mount, and wherein the camera is powered by the battery pack through the internal and exterior power bridges
wherein the stabilizer body is a pole, and wherein the pole has a distal end and a proximal end, and wherein the proximal end includes the camera mount, and wherein the distal end includes a grip, and wherein the power source is included within the grip.

3. A device for stabilizing a camera, wherein the device comprises:
a) a stabilizer body;
b) a battery pack included within the stabilizer body;
c) a camera mount connected to the stabilizer body;
d) an internal power bridge connecting the battery pack to a power out supply;
e) an exterior power bridge connected to the power out supply;
f) a camera attached to the exterior power bridge, wherein the camera is attached to the camera mount, and wherein the camera is powered by the battery pack through the internal and exterior power bridges
wherein the stabilizer body is a tripod, and wherein the tripod has three legs, and wherein the legs have a distal end and a proximal end, and wherein the legs terminate at the proximal end, and wherein the distal end is connected to a platform, and wherein the camera mount is included at the distal end, and wherein the power source is included within one of the tripod legs.

4-5. (canceled)

6. The device according to claim 2, wherein the pole comprises at least one extensible piece.

7. The device according to claim 3, wherein the tripod legs are adjustable.

8. The device according to claim 6, wherein the camera mount includes three prongs.

9. The device according to claim 7, wherein the camera mount includes three prongs.

10-18. (canceled)
